(19) United States
(12) Patent Application Publication
(10) Pub. No.: US 2010/0326550 A1
(43) Pub. Date: Dec. 30, 2010

(54) WATER DIVERSION AND COLLECTION APPARATUS

(76) Inventor: Richard Martin WRAY, Leeds (GB)

Correspondence Address: SUGHRUE MION, PLLC, 2100 PENNSYLVANIA AVENUE, N.W., SUITE 800, WASHINGTON, DC, 20037, US

(21) Appl. No.: 12/491,810

(22) Filed: Jun. 25, 2009

(51) Int. Cl. F16L 27/00

(52) U.S. Cl. 137/580

(57) ABSTRACT

A water collector for use with a drainpipe comprising an aperture and a valve associated with at least one said output aperture wherein the valve can be selectively moved to permit the flow of fluid through its associated aperture in a first position or to restrict the fluid flow through such aperture in a second position. The valve is activated from its first position to its second position via the action of a cable upon the valve. The valve is pivotally connected to the drainpipe and configured to be moved about the pivot by the action of the cable.

### FIELD OF THE INVENTION

The present invention relates to water carrying pipes and in particular to a water saving connector for use with drainpipes, down pipes and the like.

### BACKGROUND OF THE INVENTION

In general drainpipes are used on buildings and comprise a water collecting aperture or gutter that is adjacent to an upper region of a building to collect water and one or more vertical pipes for conducting the water down to a drain at ground level. During periods of time when either water is expensive or alternatively in short supply it is useful to be able to collect water from drainpipes for domestic use or to water a garden.

For this purpose, hose pipes may be connected at a point to a drainpipe and the hose pipe may then lead into, for example a bath or other storage structure where water can be stored for later use. It is however common for the use of hose pipes to be completely banned during drought conditions so that this method is also not permitted.

In such times of restricted water if rain does occur only a limited percentage is retained through a hose pipe connected to a vessel for storage. Therefore, the ability to recycle other types of water such as domestic water bath water is vital.

Furthermore, it can be difficult to adequately connect a hose pipe to a drainpipe since the latter generally has a larger diameter. It is known to use a drainpipe connector which has a body adapted to be connected at a suitable location in a vertical drainpipe and which thereby forms part of the drainpipe and which has a side pipe extending downwardly from the body. A side pipe can be adapted to connect to a hose pipe while the main drainpipe body leads to a drain. A major disadvantage of all the previously discussed connectors is that most of the water goes straight down a drainpipe or other down pipe to the drain, only a small portion of it being guided into the side pipe and therefore redirected so as to be reusable.

An alternate type of prior art water re-directional diversion device comprises a rigid plastic tube that can be fitted into the interior of a drainpipe. Inside the rigid plastic tube is a smaller diameter rigid tube that is open at the bottom such that anything that passes into the tube can pass entirely through standpipes. The smaller tube is spaced from the inside wall of the plastic tube by a distance of between 5 mm to 40 mm. It has been found that water flowing down the drainpipe will preferentially flow into this spacing, this is thought to occur due to the well known effects of surface adhesion which means that water will preferentially flow along the inside wall of the drainpipe.

The lower end of the smaller inner tube is open to waste and the area between the inner tube and the outer plastic tube forms a reservoir which contains an outlet to which a garden hose can be fitted to drain water to a desired place in a garden or to replace storage or for some other function. Indeed, the hose can be used to fill a swimming pool for instance, or to divert water to any other suitable location.

While this device has been used for several years and is efficient in its operation there are circumstances, for instance, during a substantial rain shower where so much water flows into the device that the garden hose cannot cope with the flow of water which means that ultimately valuable water backs up and overflows through the inner tube and down to the waster or drain associated with the drain pipe.

Therefore, there would be an advantage to provide a water diversion device which could be configured so as to direct greater or lesser amounts of water flowing through the associated drain pipe and diverting such water via a second pipe to a place of storage or alternatively to a location where this water could be used most productively.

The present invention provides a new solution to the collection of rain water and other waste water from drain and other down pipes present in domestic or commercial properties and overcomes the above disadvantages.

### SUMMARY OF THE INVENTION

According to a first aspect there is provided a connector for use with a drainpipe comprising an aperture, and valve means associated with at least one said output aperture wherein the valve means can be selectively actuated to permit the flow of fluid through such associated aperture in a first position or to restrict the fluid flow through such aperture in a second position; characterised in that said valve means is activated from said first position to said second position via the action of a cable upon said valve means and wherein said valve means is pivotally connected to said drainpipe and configured to be moved about said pivot by the action of said cable.

Preferably the valve comprises a disk.

Preferably the disk is moveable between a first position in which the disk lies substantially perpendicular to the aperture and a second position in which the disk lies substantially parallel to the aperture.

Preferably the aperture comprises a flexible flange member extending substantially around the periphery of said aperture and configured to interact with said valve means so as to form a watertight seal when said flexible flange member is in contact with said valve.

Preferably the aperture comprises a filtration means configured to remove particular and other matter from fluids flowing through said aperture.

Preferably the filtration means comprises a sieve configured to remove particular matter from said fluid flowing through said aperture.

Preferably the filtration means comprises an anti-microbial mechanism configured to reduce the number of microbiological organisms present in said fluid flowing through said aperture.

Preferably the valve means comprises a safety mechanism configured to actuate said valve from said first position to said second position if pressure exerted upon said valve means by said flow of fluid is greater than a pre-determined value.

Preferably the valve means comprises a flexible flange member extending substantially around the periphery of said valve means;

wherein said flexible flange member is configured to form a water tight seal with said aperture when in contact with said aperture.

Preferably the cable is composed of an organic polymer.

Preferably the cable comprises a metal inner core surrounded by an organic polymer laminate.

Preferably the cable is connected at a first end to said valve means and at a second end to a winch mechanism;

wherein said winch mechanism comprises a ratchet configured to allow free movement of said winch in a first direction whereby movement in said first direction causes said valve means to move into said second position; and

wherein said winch comprises a release mechanism configured to allow said winch mechanism to move in a second direction so facilitating the movement of said valve means towards a first position.

Preferably the pivot comprises a ratchet mechanism configured so as to allow the adjustment of said valve means only over pre-determined measurements of its overall ark of movement.

Preferably the pivot comprises a ball and socket arrangement.

Preferably the aperture is associated with a pipe through which said fluid may flow.

Preferably the pipe member is substantially flexible.

Preferably the pipe member comprises a fabric material.

Preferably the pipe member comprises a concertina material.

Preferably the pipe means terminates in a filtration means configured to purify said fluid which flows there through.

Preferably the associated pipe member comprises a tap member.

Alternatively there is provided a connector downpipe substantially as herein before described with reference to the accompanying drawings.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

With reference to FIG. 1 herein there is shown a view of water collection apparatus according to a first specific embodiment of the present invention.

With reference to FIG. 2 herein there is shown a water collection apparatus according to a second specific embodiment of the present invention.

With reference to FIG. 3 herein there is shown a water collection apparatus in accordance with a third specific embodiment of the present invention.

With reference to FIG. 4 herein there is shown a water collection apparatus according to a fourth specific embodiment of the present invention.

With reference to FIG. 5 herein, there is shown a water collection apparatus according to a fifth aspect of the present invention.

With reference to FIG. 6 there is shown a preferred embodiment of the fifth aspect of the present invention.

FIG. 7 shows a preferred embodiment of the fifth aspect of the present invention.

FIG. 8 shows a preferred embodiment of the fifth aspect of the present invention.

FIG. 9 shows a sixth aspect of the present invention.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

According to the invention there is provided a connector 101 for use with a drainpipe 102. The connector 101 comprises an aperture 103, and a valve means 104 associated with the aperture 103 wherein the valve means 104 can be selectively moved to permit the flow of liquid through the associated aperture 103 or to restrict the fluid flow through this aperture 103.

The invention also provides a drainpipe 102 having the invention connected thereto or integral therewith.

Preferably, the valve means 104 comprises a mechanical valve moveable between a first position in which fluid flow through the aperture 103 is permitted and a second position in which fluid flow through the aperture 103 is restricted.

The valve means 104 comprises a disk or other shape which, for example, may be a molded plastic disk and which is preferably similar in shape and dimension to the interior of the drainpipe 102. The disk 104 may be moveable from the first position in which the valve lies substantially perpendicular to the aperture 103 and a second position in which the disk lies substantially parallel to the aperture 103.

The valve means or the disk 104 is manually operated to move between these first and second positions. The disk 104 may be mounted on a pivot 105. The valve means 104 may be moved from a first to a second position by the action of a cable 106 connected to the valve means 104. This cable 106 passes through a hole 107 in the wall of the drainpipe 102 and is located in a substantially parallel orientation to the drainpipe 102 down to a fixing means 108 about which the cable 106 may be affixed. The relative orientation of the valve means 104 can therefore be adjusted via pulling or releasing lengths of the cable 106 and the valve means 104 can be fixed in position by tying or otherwise affixing the cable 106 about the fixing means 108.

Sealing means such as grommets may be positioned between the hole 107 and the cable 106 to prevent water leakage. Sealing means may also be provided on the valve means 104 such that when in the fluid restriction position it prevents fluid entry through the aperture 103. Such sealing means may comprise a seal located around the peripheral edge of the valve.

The valve means 104 further comprises a biasing means 113. In accordance with the present invention this biasing means is in the form of a compression spring. This compression spring is connected to a portion of the drainpipe 102 and to a portion of the disc 104. The biasing means 113 is configured so as to positively bias the valve means into a second position wherein the valve means extends across the entirety of the drainpipe 102 and any fluid flowing down the drainpipe 102 is diverted into the side pipe 109 via the aperture 103. According to a further embodiment of the present invention. The biasing means may be protected from corrosion by enclosing it in a waterproof sheath, also the spring may be coated in such a substance or made from a waterproof substance.

A handle may be located on a drum configured to rotate and collect the cable 106 to facilitate the operation of the valve 104, turning of the handle causing the cable to be collected and thereby causing the disk supported thereof to rotate about the axis of the pivot.

The cable may be retained on the valve 104 by any suitable means such as knots, loosely secured or threaded with a flattened portion to prevent regress of the cable 105 out of the hole in the valve 104 through which it is threaded. The valve may be moved to any position between the first and second position depending upon the amount of fluid flow required through the aperture.

The connector 101 comprises a body having the aperture 103 at one side thereof and an output or through aperture, arranged perpendicularly thereof.

The aperture 103 is connected to a side pipe 109. The side pipe 109 may extend from the body 101 at a downwards angle or at a substantially right angle to the drainpipe 102. Preferably means are provided on the aperture 103 to facilitate connection of the aperture 103 to the side pipe 109. Such means, for example, may comprise a threaded coupler. The side pipe 109 is preferably substantially cylindrical.

In accordance with a further aspect of the present invention the connector apparatus 101 are configured as to be sold as a separate unit from drainpipes and other suitable water bearing down pipes. In this instance therefore it is necessary to connect the connector 101 to the drainpipe. To do this a section of a drainpipe 102 is cut away and the body of the connector 107 is connected to the drainpipe 102 in place of the cut away section. The side pipe 109 then extends outwardly from the drainpipe 102 and may be connected using suitable piping or hosing to lead a bucket or other reservoir for collecting rain water.

In accordance with a further aspect of the present invention there is also provided a return pipe 110. This return pipe 110 is configured to allow liquid diverted through the side pipe to a water reservoir back into the drainpipe 102. This mechanism allows or seeks to prevent flooding of the reservoir if too large a quantity of water is introduced into the reservoir for the reservoirs inherent capacity. It also allows the reservoir tank to be drained such that maintenance or other operations can be conducted thereon. The return pipe 110 is connected to the drainpipe in a similar fashion to the connector 101 and side pipe 109 as previously explained and any suitable normal connection means may be used to connect the return pipe to the drainpipe body 102.

With reference to the rest of this water collection and recycling system there is provided a gutter 111. The gutter 111 is positioned around the periphery of a commercial or residential property roof and is configured to receive water which may flow off these roof structures into the gutter. The gutter is also operably connected to the drainpipe 102 such that water collected in the gutter is transmitted into the drainpipe.

At a bottom end of the drainpipe 102 there is also provided a drain 112. This drain connects to the municipal water collection system and allows the water expelled by the drainpipe 102 to be collected municipally and recycled as appropriate or alternatively treated and disposed of.

When the valve 104 is open that is in the first position, rainwater preferentially flows through the body 101 and down the drainpipe 102. When the valve is moved to the closed or second position water is prevented from flowing through the drainpipe 102 and must flow through the side pipe 109 for collection as required. It will be seen that all rainwater entering the drainpipe can be caused to flow through the side pipe 109.

With reference to FIG. 2 herein there is shown a further embodiment of the present invention. This embodiment again comprises a connector 100 for use with a drainpipe 102. In accordance with this particular embodiment of the present invention this connector comprises a separate unit which can be connected to a first section and a second section of the drainpipe so forming a continuous structure therewith. In addition, the connector 101 is also provided with a substantially distended portion 201 which is configured so as to allow the passage of said valve means 104 about said pivot 105 when move from a first to a second position as per the previous embodiment of the present invention.

As per the previous embodiment of the present invention, this connector 101 comprises a valve means 104 that is operatively connected to said connector at said pivot point 105. This valve means 104 is capable of movement from a first to a second position in said first position the valve means lie substantially perpendicular to an aperture 103 formed into said connector 101.

In accordance with the specific embodiment of the present invention the pivot 101 comprises a bull and socket arrangement allowing the valve means 104 a greater range of movement in both a first and second plane substantially perpendicular and horizontal to the longitudinal axis of said drainpipe 102. This greater range of movement allows the valve means to self adjust if during a manual adjustment to the valve a great volume of water or other debris is impacting upon the valve so increasing its working efficiency.

In accordance with further embodiments of the present invention the pivot means 105 associated and operably connected between the valve means and connector may also comprise a ratchet mechanism configured to allow the adjustment of the valve means in pre-determined quantitised steps over its total range of movement. This ratchet or quantitised adjustment mechanism again improves the operating efficiency of the valve means as, by adjusting the valve means about its quantitised pivot mechanism this can allow the valve means to be set very accurately at a range of different angles relative to the longitudinal axis of said drainpipe so directing a greater or less proportion of the fluid flowing down said drainpipe as appropriate to the current environmental conditions.

In accordance with this further embodiment of the present invention there is also provided a filter mechanism 202. This filter mechanism 202 is positioned inside of the side-pipe 109 into which water is diverted by said valve means 104 and said connector 101. This valve means functions to remove particulate matter from the fluid flowing into said side pipe via said valve means. The water in said drainpipe is collected from gutters and other structures associated with the exterior of a property. These gutters can become contaminated with leaves and other matter which can itself in turn lead to the contamination of any rain water which collects in these structures and eventually flows down said drainpipe. If water is to be re-used for certain purposes, for instance, in a household task it is important that the water is as pure and clean as possible. In any event, if the water collecting is to be stored for any amount of time before use it is important as far as possible to remove as higher percentage of contaminants as possible as the inclusion of organic or other matter in stored bodies of water would lead to the contamination of such bodies of water with powerful microbiological organisms and general levels of toxic chemicals associated with the decomposition of organic matter.

In accordance with the specific embodiment of the present invention the filtration means 202 associated with the side pipe 109 of the present apparatus comprises a number of strong fine but actually overlapping threads which act to move particular and other contaminant matter from the water flowing through said pipe. In addition, and in accordance with further embodiments of the present invention the filtration means may comprise further elements configured to remove or reduce the numbers of microbiological organisms or to remove a higher percentage of the particular or contaminate present in the fluid.

With reference to the enlarged portion of FIG. 2 showing an enhanced view of this filtration portion of the current apparatus. The filtration member 204 is surrounded by a frame member 203. This frame member 203 is capable of insertion and removal from the side pipe via the insertion and removal of plastic holding members through loops formed into said side pipe and said filtration means.

The removal of the filtration means 202 is necessary as overtime and accumulation of particular and other matter will become associated with the filtration means and this will need to be removed from the filtration means so as to allow the filtration means to act in a most efficient fashion and also so as to allow the flow of fluids through said filtration means.

With reference to FIG. 3 there is shown a further embodiment of the present invention. In accordance with this further embodiment of the present invention there is again provided a connector 101 associated with a drainpipe 102 which is itself attached to the exterior of a property and associated operatively with one or more cutters configured to collect rain water and direct such rain water into the drainpipe 102. The connector again comprises a valve means 104 operatively associated with aperture 103 through which the directed water is configured to flow into side pipe 109 away to a storage vessel or alternatively to be directed for immediate use.

The valve means 104 is operatively connected to a winch number 301 via a cord 106. This cord is substantially composed of a braided metallic cord surrounded by a plastic sheath laminated onto this braided metallic cord. Such a cord is strong and unaffected by the elements via the associated plastic lamination. This cord is connected at a first end to the valve means 104 and at a second end to a winch 301.

This winch comprises a ratchet mechanism which when turned in a first direction allows a winch to move in pre-determined quantitised intervals so via the action of the cord upon the valve means 104 causes the valve means to move in similarly pre-determined quantitised angles of movement about said pivot 105 to which said valve means 104 is operably attached. The ratchet mechanism associated with the winch 301 also acts as a lock so fixing the associated valve means 104 in a pre-determined position chosen by the operator of the winch mechanism. The winch mechanism also comprises a release trigger, the operation of which allows the winch mechanism to move in a second direction so moving an associated valve means in a second direction about said pivot means.

With reference to FIG. 4 that is shown herein a further connector 101 associated with a drainpipe 102. This drainpipe again being operably being connected to an associated system of guttering configured to collect and direct rain water and other fluids into the drainpipe. The connector 101 again comprises a valve means 104 operably connected to said connector mechanism via a pivot 105. Associated with the connector is an aperture 103 through which fluid may flow into a side pipe 109.

In accordance with this specific embodiment of the present invention this side pipe 109 itself flows into a storage vessel 401. This storage vessel is configured to contain a significant quantity of water. This storage vessel 401 itself comprises a dispensing mechanism in the form of a tap 402. This tap is configured to release a variable flow of liquid as per an adjustment to the tap mechanism. In addition to this the water storage vessel 401 also comprises a filtration means configured to remove particular and other contaminants from the water stored therein so allowing a higher quality of water to be removed from the water storage vessel via the tap means 402.

FIG. 5 comprises a galvanized cable 300, a grommet hole 310, a coiled spring 320, water diversion and collection apparatus 340, alternative water flow route 350, normal water flow direction 370 and hinged flap 400.

FIG. 6 showing water diversion and collection apparatus 340 further comprises a galvanized cable 300, grommet hole 310, coiled spring 320, water flow direction 370, hinged flap 400.

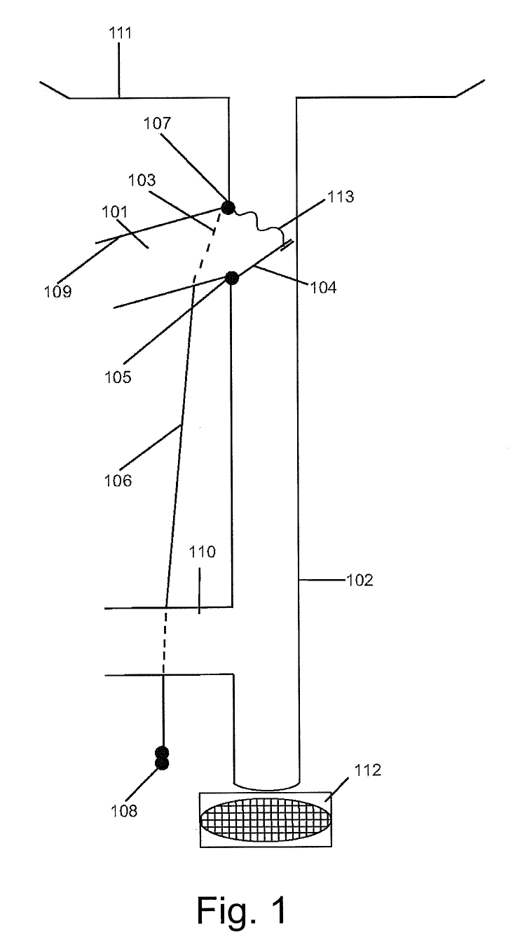

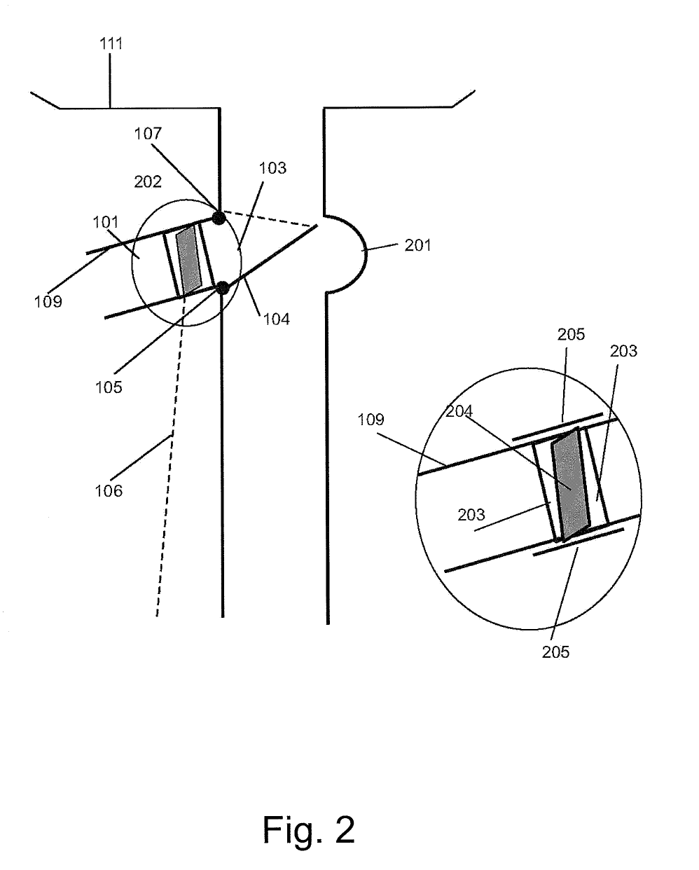

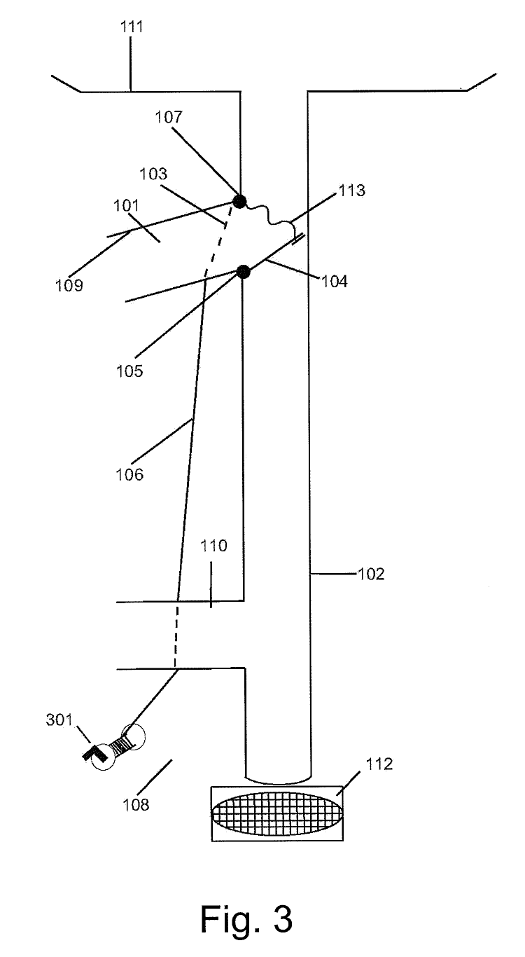

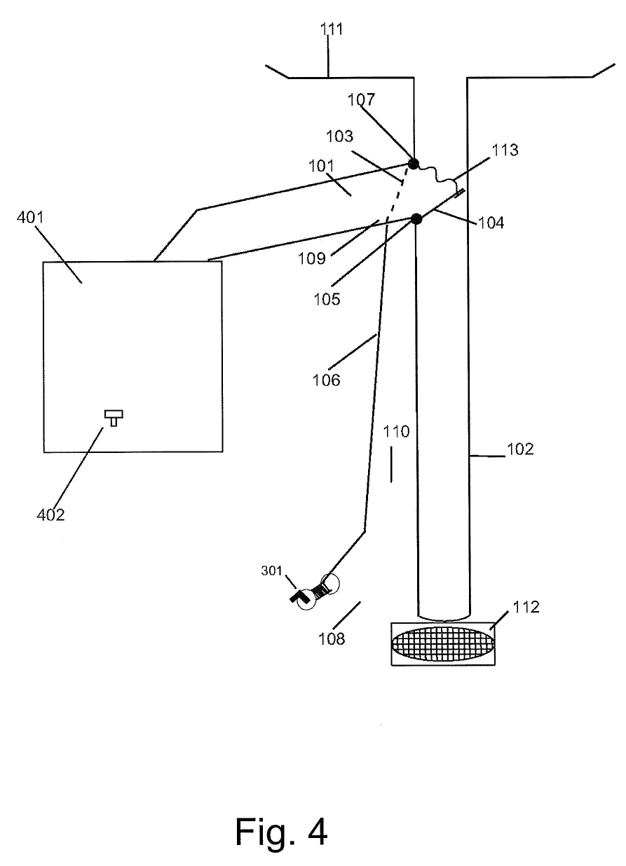

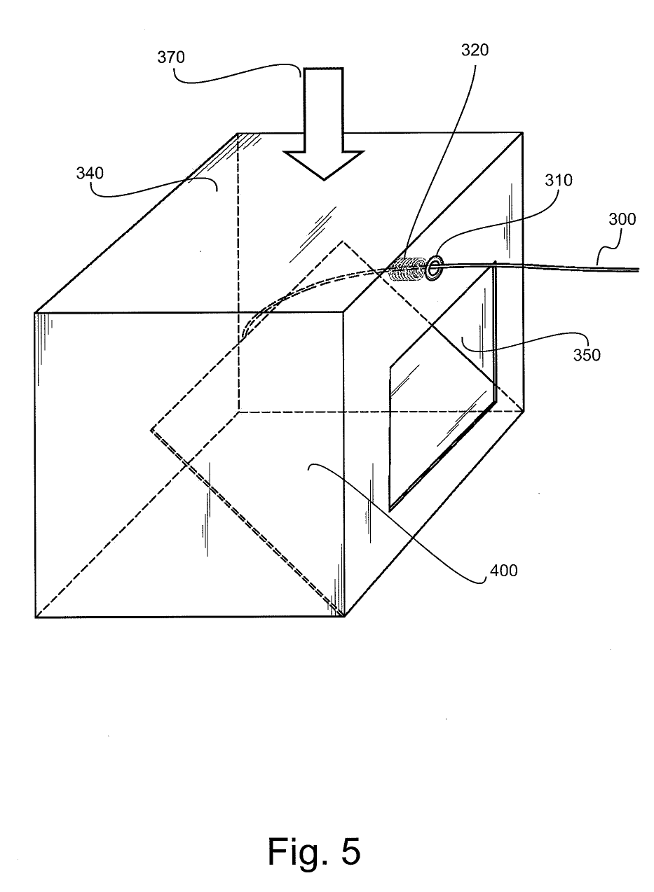

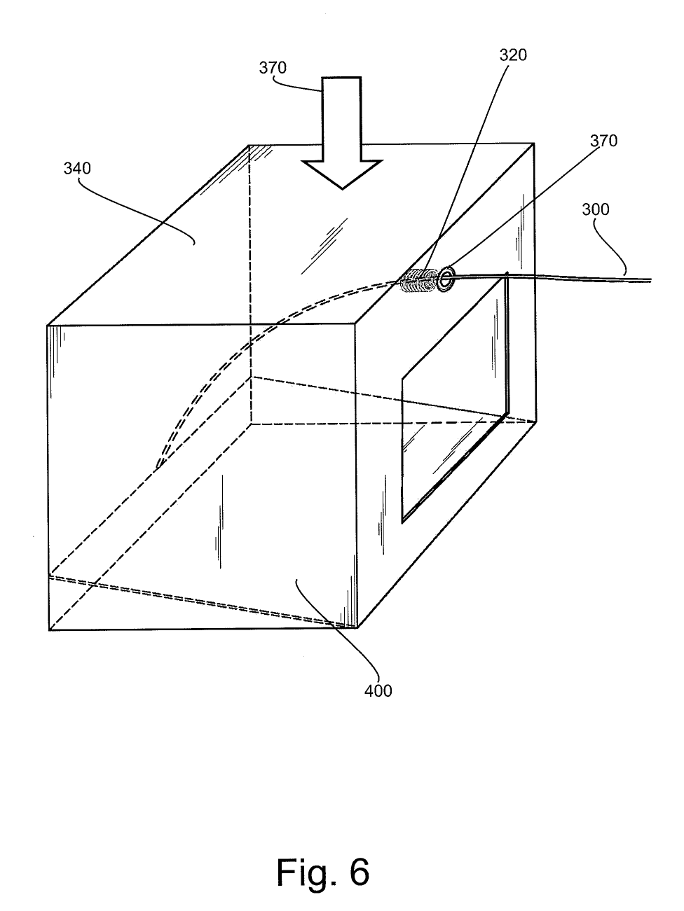

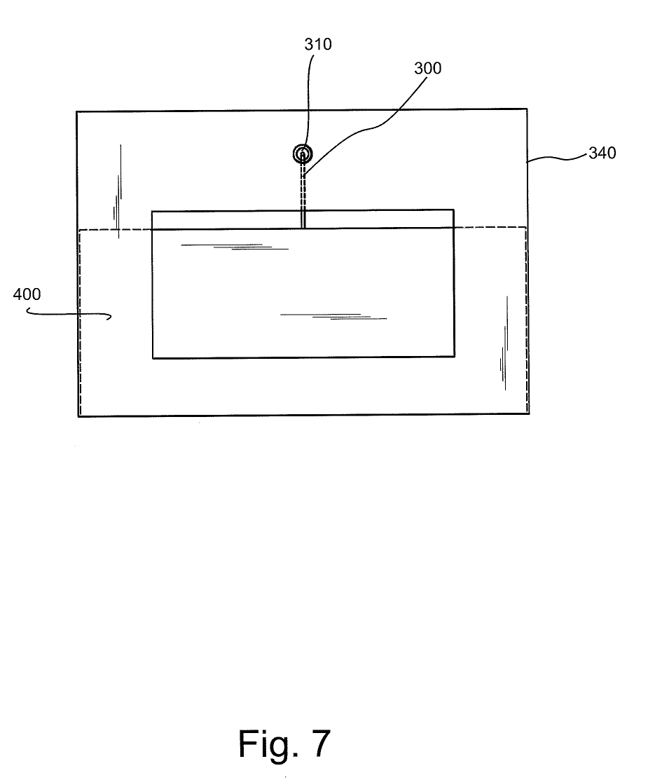

FIG. 7 shows a front on view of water diversion and collection apparatus 20 340, herein grommet hole 310, galvanized cable 300 and hinged flap 400.

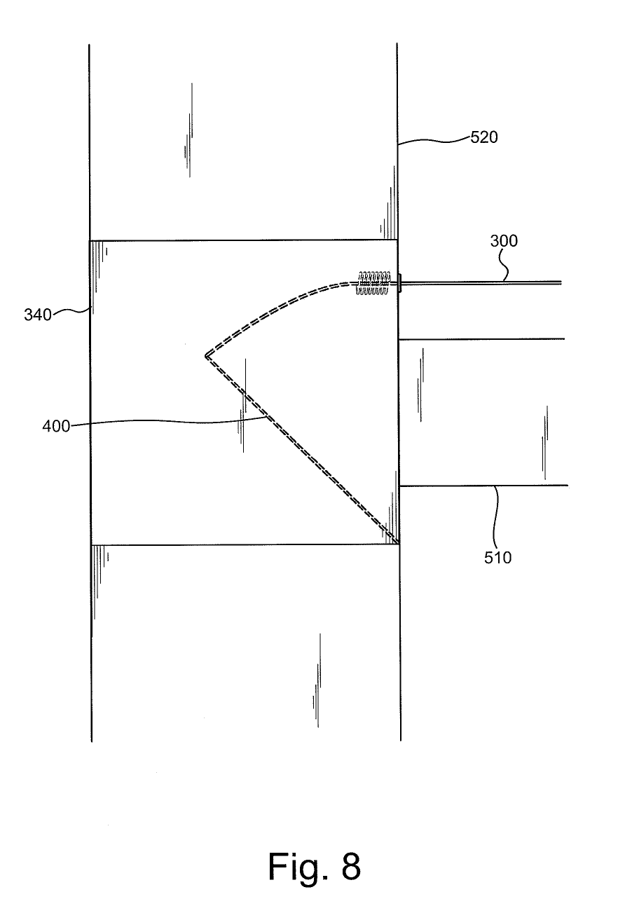

FIG. 8 shows water diversion and collection apparatus 340, hinged flap 400, galvanized cable 300, drainage fall pipe 520, and side pipe 510.

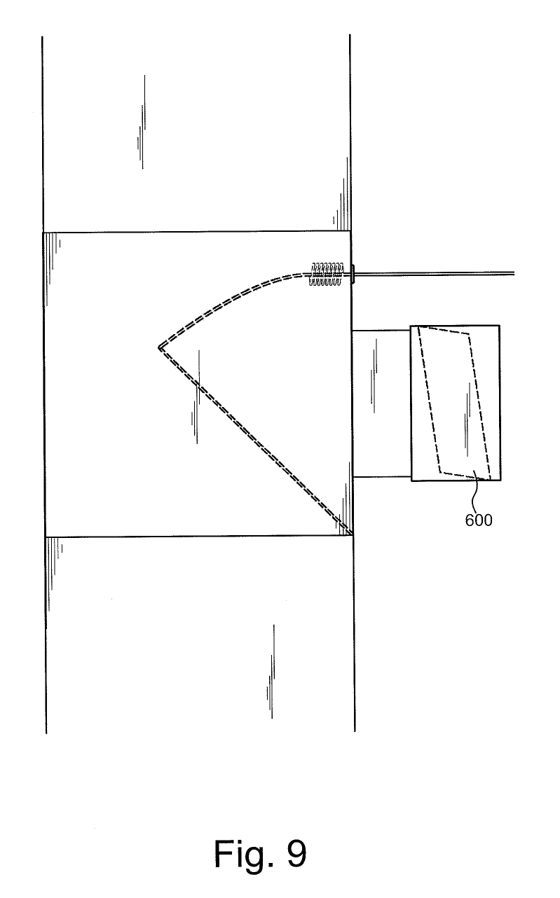

FIG. 9 shows filtration means 600.

FIG. 5 shows a preferred embodiment of the present invention whereby water collection and diversion apparatus 340 can be added to an existing fall pipe of a guttering system in order to act as a control valve to divert the water from its normal flow 370 into a side pipe 510 via diversion route 350.

In a preferred embodiment, the water flow and collection apparatus 340 fits into a standard square plastic drainpipe and controls the flow of run of water. However, alternatively, the water collection and drainage apparatus can be adapted to different shapes and sizes to fit into any drainage system to divert water from a normal flow direction to a different flow direction.

In a preferred embodiment, water diversion and collection apparatus will be substantially cubic. Each face of the water collection and diversion apparatus in a preferred embodiment will be 6.5 cm wide and 7.5 cm in height.

Furthermore, in an alternative embodiment, alternative directional route 350 will be 6.5 cm² in size. Cable 300 is galvanized in order to protect the said cable from rust and other means of wear. Alternatively, the cable may be toughened but flexible plastic. In order to adjust the hinged valve/flap 400, cable 300 is manually operated to adjust the angle of the flap in relation to the fall pipe in order to control the normal direction of flow of water 370. Coiled spring 320 and grommet hole 310 are located to ensure a smooth and standardize adjustment of hinged flap 400 via galvanized cable 300.

In a preferred embodiment, when hinge flap 400 is positioned at an angle similar to that shown in either FIG. 5 or 6 water will be diverted through diversion route 350 to a side pipe 510 whereby water will then be diverted to a storage tank 401 for recycling.

FIG. 8 shows the water diversion and collection apparatus 340 in a fixed position inserted into a fall pipe 520 at a location where diversion route hold 350 is substantially located at a side pipe 510.

FIG. 9 shows an alternative embodiment of the present invention whereby there is also located a filtration means 600 at the diversion route hole 350 or located inside the side pipe 510. The filtration means 600 is located to vent unwanted purities such as moss and stones from entering into storage means 410.

In a preferred embodiment, the normal flow in a fall pipe is vertically downwards. The water diversion and collection apparatus as for induction of a horizontal flow of water into a storage means via a side pipe. However, water diversion and collection apparatus 340 may be adapted to divert water at any angle away from the normal flow direction in a guttering system.

In a preferred embodiment, galvanized cable 300 is manually operated to open and close hinge flap 400. However, alternatively, the galvanized cable and hinged flap may be automated via a motorized, battery operated or electrically operated winder system. When hinged flap is in an open position, the angle at which the flap is locked in place at will determine how much water falls down the fall pipe and how much water is diverted to the side pipe. The hinged flap may be positioned that no water can fall down the fall pipe, or it may be positioned such that some water falls down the flow pipe. The hinged flap can be locked in a plurality of positions via a locking means which secures the galvanized cable in place. When the hinge flap is in a closed position, the flap will form a water tight seal so that no water can be diverted through diversion route 350 therefore, water can not get into side pipe 510 or into storage means 401.

1. A connector for use with a drainpipe comprising an aperture, and valve means associated with at least one said output aperture wherein the valve means can be selectively actuated to permit the flow of fluid through such associated aperture in a first position or to restrict the fluid flow through such aperture in a second position;
characterised in said valve means is activated from said first position to said second position via the action of a cable upon said valve means and wherein said valve means is pivotally connected to said drainpipe and configured to be moved about said pivot by the action of said cable.

2. A connector as claimed in claim 1 wherein the valve comprises a disk.

3. A connector as claimed in claim 2 wherein the disk is moveable between a first position in which the disk lies substantially perpendicular to the aperture and a second position in which the disk lies substantially parallel to the aperture.

4. A connector for use with a drainpipe as claimed in claim 1, wherein said aperture comprises a flexible flange member extending substantially around the periphery of said aperture and configured to interact with said valve means so as to form a watertight seal when said flexible flange member is in contact with said valve.

5. A connector for use with a drainpipe according to claim 1, wherein said apperture comprises a filtration means configured to remove particular and other matter from fluids flowing through said apperture.

6. A connector for use with a drainpipe as per claim 5, wherein said filtration means comprises a sieve configured to remove particular matter from said fluid flowing through said aperture.

7. A connector for use with a drainpipe as per claim 5, wherein said filtration means comprises an anti-microbial mechanism configured to reduce the number of microbiological organisms present in said fluid flowing through said aperture.

8. A connector for use with a drainpipe according to claim 1, wherein said valve means comprises a safety mechanism configured to actuate said valve from said first position to said second position if pressure exerted upon said valve means by said flow of fluid is greater than a pre-determined value.

9. A connector for use with a drainpipe as per claim 1, wherein said valve means comprises a flexible flange member extending substantially around the periphery of said valve means;
wherein said flexible flange member is configured to form a water tight seal with said aperture when in contact with said aperture.

10. A connector for use with a drainpipe as in claim 1, wherein said cable is composed of an organic polymer.

11. A connector for use with a drainpipe as claimed in claim 1, wherein said cable comprises a metal inner core surrounded by an organic polymer laminate.

12. A connector for use with a drainpipe as claimed in claim 1, wherein said cable is connected at a first end to said valve means and at a second end to a winch mechanism;
wherein said winch mechanism comprises a ratchet configured to allow free movement of said winch in a first direction whereby movement in said first direction causes said valve means to move into said second position; and
wherein said winch comprises a release mechanism configured to allow said winch mechanism to move in a second direction so facilitating the movement of said valve means towards a first position.

13. A connector for use with a drainpipe as per in claim 1, wherein said pivot comprises a ratchet mechanism configured so as to allow the adjustment of said valve means only over predetermined measurements of its overall ark of movement.

14. A connector for use with a drainpipe as per in claim 1, wherein said pivot comprises a ball and socket arrangement.

15. A connector for use with a drainpipe as per in claim 1, wherein said aperture is associated with a pipe through which said fluid may flow.

16. A connector for use with a drainpipe as per claim 15, wherein said pipe member is substantially flexible.

17. A connector for use with a drainpipe as per claim 15, wherein said pipe member comprises a fabric material.

18. A connector for use with a drainpipe as per claim 15, wherein said pipe member comprises a concertina material.

19. A connector for use with a drainpipe as per claim 15, wherein said pipe means terminates in a filtration means configured to purify said fluid which flows there through.

20. A connector for use with a drainpipe as claimed in claim 15, wherein said associated pipe member comprises a tap member.

21. (canceled)
